(19) United States
(12) Patent Application Publication
(10) Pub. No.: US 2013/0085883 A1
(43) Pub. Date: Apr. 4, 2013

(54) LIBRARY RESOURCE ACQUISITION

(71) Applicant: Talin Ryan Bingham, Wanship, UT (US)

(72) Inventor: Talin Ryan Bingham, Wanship, UT (US)

(73) Assignee: SIRSI CORPORATION, Provo, UT (US)

(21) Appl. No.: 13/271,950

(22) Filed: Oct. 12, 2011

Related U.S. Application Data
(63) Continuation-in-part of application No. 13/249,867, filed on Sep. 30, 2011.

(51) Int. Cl. G06Q 30/06

(52) U.S. Cl. 705/26.2

(57) ABSTRACT

Acquiring resources for a plurality of customer or patrons. A method includes receiving a plurality of requests from different customers or patrons for the same groups or individual resources. The method further includes requesting a number of licenses for the groups or individual resources in a single purchasing transaction from a publisher. The method further includes receiving the number of licenses. The licenses are distributed to the different customers based on individual customer requests

### CROSS-REFERENCE TO RELATED APPLICATIONS

This application is a continuation in part of prior application Ser. No. 13/249,867 filed Sep. 30, 2011, titled “NORMALIZING METADATA BETWEEN LIBRARY CONTENT PROVIDERS”, which is incorporated herein by reference in its entirety.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system. Interconnected computing systems can be used to implement library functionality.

Libraries have evolved slowly over time until recent times. Typically a library housed a collection of books and the quality of the library was determined by the number of volumes that the library housed and the diversity of works maintained by the library. Libraries could increase their reputation by entering into agreements with other libraries to share works through inter-library loans.

In recent history, digital (or electronic) works have been created at an astounding rate. Such digital works may include original works created by authors and distributed digitally alone or along with printed versions; automatically generated digital works aggregating content from other digital works; digital works created from works formerly available only in printed form, such as by scanning, optical character recognition, transcribing, etc.; digital audio or video recordings; etc. The growth of the body of available digital works has been exponential in nature. To stay relevant, libraries have had to adapt to be able to provide digital works as well as physical works to patrons. Digital works may be delivered electronically as a digital download via a communication medium such as a network.

As with physical works, digital works are typically protected by intellectual property rights that allow authors and publishers to collect royalties for use of the works. With physical books, collecting royalties and determining that a work is authorized is quite simple. Physical possession of the book by a library typically indicates purchase of the book where at least a portion of the purchase price is paid as a royalty to an author and/or publisher. Unauthorized copies of physical works are often degraded in quality as exact copies are difficult if not impossible to make. For digital works it can be more complicated to collect royalties and to know that appropriate royalties have been paid. It is often trivial to create an exact copy of a digital work, and possession of a high-quality copy does not indicate that the appropriate royalties have likely been paid.

Digital works are distributed by digital content publishers. Each digital content publisher has their own interface and requirements for being able to obtain digital works from that publisher. Additionally, publishers may have their own content protection schemes to prevent unauthorized access or copying of digital works.

With digital works, as outlined above, it is trivial to create an exact copy of the digital work. In spite of this, it is nonetheless generally illegal for a library to obtain a work for the library by simply copying the digital work from another who has already obtained the digital work. Additionally, digital content publishers may implement digital rights management (DRM) to prevent digital works from being copied, or to make copies unreadable or inaccessible. Thus, for a library to offer a digital work as part of its collection, the library must obtain the digital work from an authorized source. Thus, the ease of obtaining and storing digital works does not fully eliminate the cost of obtaining digital works.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein is directed to a method practiced in a digital library environment. The method includes acts for acquiring resources for a plurality of customer or patrons. The method includes receiving a plurality of requests from different customers or patrons for the same groups or individual resources. The method further includes requesting a number of licenses for the groups or individual resources in a single purchasing transaction from a publisher. The method further includes receiving the number of licenses. The licenses are distributed to the different customers based on individual customer requests.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an environment that allows electronic resources to be delivered from a library;

FIG. 2 illustrates an aggregator module; and

FIG. 3 illustrates a method of a method of acquiring resources.

### DETAILED DESCRIPTION

Embodiments may be directed to method of obtaining digital works from publishers in a fashion that allows the digital works to be obtained under favorable acquisition terms. Embodiments may be directed to acquiring, in bulk, digital work licenses and then sub-dividing and distributing the licenses. This may allow for an intermediary party, intermediate to publishers of digital works and consumers of digital works to effectively manage digital work licenses.

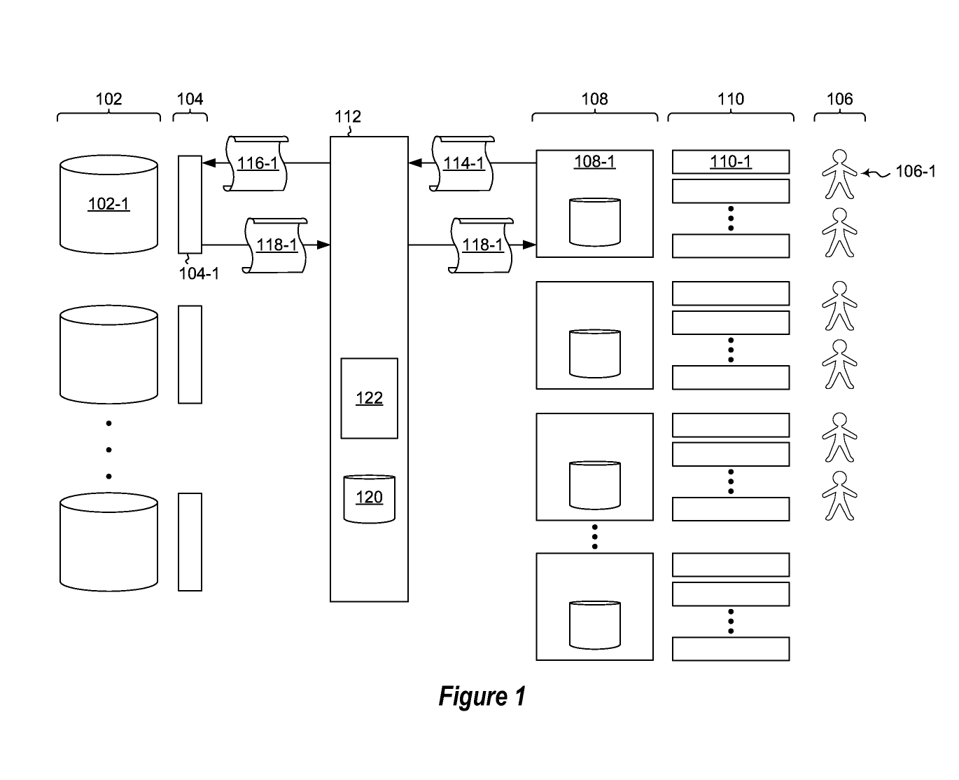

Referring now to FIG. 1, an example is illustrated. FIG. 1 illustrates a set of digital content publishers 102. The digital content publishers 102 provide digital works to consumers of the digital works.

Each of the content publishers provides content using a specific format. In the example shown in FIG. 1, a set of specific publisher interfaces 104 are shown. Each interface for each publisher may be slightly or drastically different from an interface for a different publisher. In addition to the specific publisher interfaces, a publisher may use Machine Readable Catalogue (MARC) interfaces/messages to determine what content is at a particular publisher. MARC messages may provide bibliographic information and related information about works. For example, a MARC message may provide information that may include, for example, title, author, publisher, copyright date, etc.

FIG. 1 illustrates a set of patrons (sometimes referred to herein as users) 106. Patrons are, in some embodiments, the end use consumers of digital and physical content. The patrons may obtain the resources from the publishers 102. Patrons 106 may obtain content from the publishers 102 either directly from the publishers 102 or through an intermediary. If content is obtained directly from the publishers 102, then a patron will likely use a different user interface 104 for each different publisher from which a patron obtains content. For example, each publisher in the set of publishers 102 may have different ways of specifying resources to accessed, different authentication protocols for authorizing a user to access a resource, etc.

Even using certain intermediary models, a patron may still need to use a different user interface for obtaining a resource from a different publisher. For example, FIG. 1 further illustrates a set of integrated library systems (ILSs) 108. Each ILS is associated with one or more interfaces as illustrated by the set of ILS user interfaces 110. Each of the ILS user interfaces in the set of ILS user interfaces determines how a patron will interact with an ILS in the set of ILSs 108. The ILS interfaces may be user interfaces available for different purposes or different user environments. For example, some interfaces in the set of interfaces 110 may be designed for use with a web browser. Other interfaces in the set of interfaces 110 may be designed for use with a stand-alone application such as an “app” on a mobile device or a widget. Still other interfaces in the set of interfaces 110 may be designed for use as portals in an enterprise environment. While a user may be able to consistently use one or more of the interfaces in the set of ILS interfaces 110, a given ILS may direct a patron directly to a publisher in the set of publishers 102 to obtain a given resource. This causes the patron to access a user interface provided by the publisher, which as noted above may vary from one publisher to the next.

However, embodiments may use an intermediary proxy between patrons and publishers which allows patrons to use a consistent interface regardless of the publisher. FIG. 1 further illustrates a centralized electronic resource system 112. The centralized electronic resource system 112 includes the ability to communicate using any one of the interfaces 104. In this way, the centralized electronic resource system 112 can access the publishers 102 and store content from the publishers 102. The centralized electronic resource system 112 can also pass credential information from the patrons 106 thru to the publishers 102. The centralized electronic resource system 112 can present appropriate credentials to the publishers 102 as if the centralized electronic resource system 112 were the patrons 106. The centralized electronic resource system 112 can then pass the resources on to the patrons 106. All of this can be done in a consistent manner which allows patrons to have a consistent user interface to obtain resources irrespective of what publisher is eventually used to obtain resources.

Illustrating now a specific example, a patron 106-1 may send a request 114-1 for an electronic resource 118-1 using an interface 110-1 of an ILS 108-1. The request 114-1 is intercepted by the centralized electronic resource system 112. In some embodiments, the request 114-1 may be in a standard form appropriate for the centralized electronic resource system 112, but that can be sent without respect to the eventual source of an electronic resource (i.e. a publisher). The centralized electronic resource system 112 converts the request 114-1 to a request 116-1 in format and a protocol appropriate for the specific publisher 102.

In some embodiments as outlined below, the centralized electronic resource system 112 is able to convert a request 114-1 to the request 116-1 in an appropriate format and protocol based on normalized metadata. In particular, the centralized electronic resource system 112 may receive metadata from a publisher. The metadata may include specific information about how the publisher can be accessed. This metadata can be normalized such that a request 114-1 can be consistent no matter from what eventual publisher an electronic resource 118-1 is obtained.

In some embodiments, the centralized electronic resource system 112 may act as a proxy for the patron 106-1 or the ILS 108-1. For example, the centralized electronic resource system 112 may receive authentication credentials (e.g., username and password) from the patron 106-1. The centralized electronic resource system 112 may then present these credentials to the publisher 102-1 as if the centralized electronic resource system 112 were the patron 106-1. The publisher 102-1 will then interact with the centralized electronic resource system 112 as if it were the patron 106-1.

The publisher 102-1 returns a resource 118-1 based on the request 116-1. The resource 118-1 can then be sent to the ILS 108-1 and finally to the patron 106-1.

The resource 118-1 can be delivered to the patron 106-1 in one or more of a number of different formats depending on technology at the disposal of the patron 106-1. In particular, the patron may have one or more of a personal computer, an e-book reader, a tablet device, a cell-phone, a handheld electronic device, or other device. The publisher 102-1 may provide the resource 118-1 in a format appropriate for the device(s) available to the patron 106-1. In some embodiments, a patron may be able to register with the centralized electronic resource system 112 what devices the patron 106-1 has. The centralized electronic resource system 112 can then automatically, or at the request of the patron 106-1, obtain a particular format of the resource 118-1 appropriate for the patron 106-1. Alternatively, the patron may be prompted to select an available format from a list of formats provided by the publisher for the specific resource.

In some embodiments, the publisher 102-1 may provide the resource 118-1 in a format based on interaction with the centralized electronic resource system 112. For example, the centralized electronic resource system 112 may request a format that the centralized electronic resource system 112 knows is supported by devices in possession of the patron 106-1. For example, the publisher 102-1 may include protocol features that allow the centralized electronic resource system 112 to specify a particular format. The centralized electronic resource system 112 can use these protocol features to request a particular format of the resource 118-1.

Alternatively, the centralized electronic resource system 112 may act as a proxy for a particular device in possession of the patron 106-1, and receive formats based on what type of device the publisher 102 thinks that it is interacting with irrespective of the actual type of device the publisher 102 is interacting with. In this example, the publisher 102 provides resources in a format based on the type of device with which the publisher 102 believes it is interacting. Thus for example, the publisher may believe that it is interacting with an e-book, and therefore provide a format appropriate for an e-book. Illustratively, the centralized electronic resource system 112 may spoof a user agent appropriate for a particular device in possessions of the patron 106-1. For example, nearly all web browsers specify a user agent when making HTTP requests. The user agent may identify an operating system, browser client and other information. Thus, even though the centralized electronic resource system 112 is not necessarily running a particular operating system, such as a mobile device operating system, the centralized electronic resource system 112 can spoof a user agent that causes the publisher 102-1 to believe that the centralized electronic resource system 112 is running the spoofed operating system. This may cause the publisher 102-1 to deliver the resource 118-1 in a format appropriate for the spoofed user agent to the centralized electronic resource system 112. The resource 118-lean then be delivered to the ILS 108-1 and/or the patron 106-1 in a format appropriate for the patron 106-1.

In some embodiments, the electronic resource 118-1 is returned thru the centralized electronic resource system 112 immediately upon request or very shortly thereafter. However, in other embodiments, the actual electronic resource 118-1 may not be delivered to a patron's device until later. For example, the electronic resource may not be delivered until the patron 106 opens up the appropriate e-book reader or other reader application. For example, in some embodiments, the patron 106 makes the request and the electronic content is effectively “checked out” to the patron 106, but the electronic resource 118-1 itself stays at the publishers database 102-1 until the patron 106 opens their e-book reader or other appropriate software application and does a synchronization process.

The centralized electronic resource system 112 may include functionality for obtaining a plurality of different formats of the electronic resource 118-1 for the patron 106-1. For example, the patron 106-1 may have access to a number of different devices capable of rendering electronic resources. For example, the patron 106-1 may have a smart phone, an e-book reader, a tablet device, a laptop, etc. The centralized electronic resource system 112 can download different formats of the same electronic resource 118-1, one suitable for each device. In particular, each device may have different formatting and/or digital rights management (DRM) schemes. The centralized electronic resource system 112 can obtain, e.g. by direct request or acting as a proxy, different formats of the same electronic resource 118-1 with appropriate formatting and/or DRM protocols.

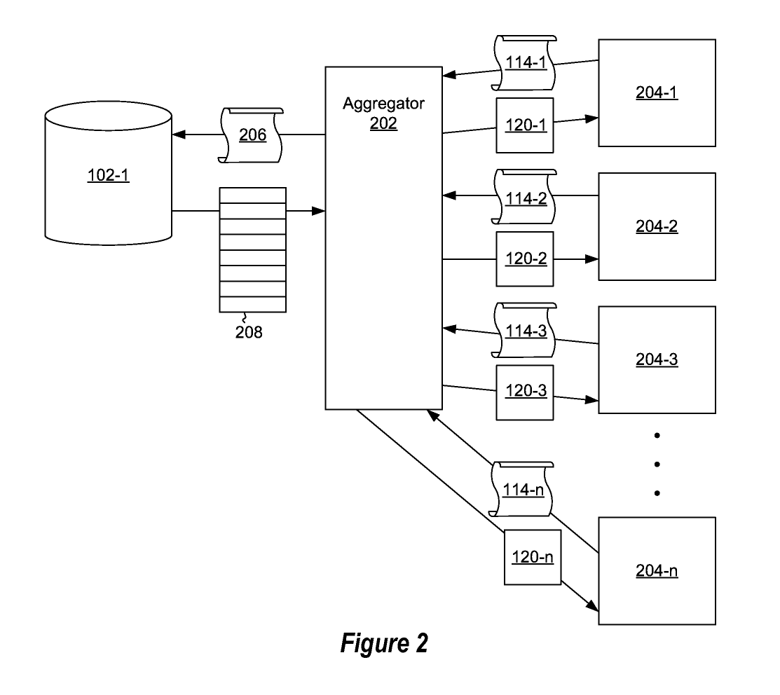

Referring now to FIG. 2 additional details are illustrated. FIG. 2 illustrates an aggregator module 202. In some embodiments, the aggregator module 202 may be implemented in the centralized electronic resource system 112 illustrated in FIG. 1. The aggregator module 202 receives requests for electronic resources, and in particular requests for licenses for electronic resources from entities 204-1, 204-2, 204-3 and 204-n. In the example illustrated, requests 114-1, 114-2, 114-3, and 114-n are illustrated. Each of the requests 114-1 through 114-n may request one or more licenses for one or more electronic resources. While FIG. 2 illustrates requests on a one to one basis with entities, it should be appreciated that embodiments are not constrained to this. Rather, embodiments may allow for entities to submit multiple requests either as individual requests or as an aggregated set of requests.

The aggregator 202 aggregates the requests 114-1 through 114-n based on one or more of a number of different factors as will be explained in more detail below. However, the aggregator may aggregate requests based on one or more common characteristics. For example, the aggregator 202 may aggregate requests from different entities for the same electronic resource. The aggregator then sends an aggregated request 206 for one or more electronic resources, where the aggregated request 206 is based on aggregating requests from entities, such as requests 114-1 through 114-n. Illustratively, suppose that request 114-1 requested four licenses of a particular resource, and that requests 114-1 through 114-n requested a total of three licenses for the same particular resource. The aggregator could send an aggregated request 206 to a publisher 102-1 for seven or more licenses based on the requests 114-1 through 114-n.

As illustrated in FIG. 2, the publisher 102-1 returns a block of licenses 208 to the aggregator 202. The aggregator 202 can divide the licenses among the entities 204-1 through 204-n that requested them and send individual licenses 120-1 through 120-n so as to satisfy the requests 114-1 through 114-n sent by the entities 204-1 through 204-n.

While the example illustrated in FIG. 2 illustrates the aggregated request 206 being sent after the requests 114-1 through 114-n, request 206 could be sent before receiving requests 114. In particular, the aggregator could request a block of licenses 208 using a request 206 prior to actually receiving any or all of the requests 114-1 through 114-n. For example, the aggregator 202 may request the block of licenses 208 prior to receiving any of the requests 114-1 through 114-n based on an anticipated number of licenses to be requested. Alternatively, the aggregator 202 may have received a portion, but not all, of the requests 114-1 through 114-n. The aggregator 202 may nonetheless request more licenses in the block of licenses 208 than have been requested in aggregate in the received requests from entities based on the anticipation that more licenses will eventually be requested from entities at a later time.

As alluded to previously, the aggregator 202 may send an aggregated request based on one or more of a number of different factors. As described above, one such factor may be requests for the same resource or group of resources. Thus, if several different entities request the same resource from the aggregator 202, the aggregator 202 can request multiple licenses of the same resource.

Alternatively or additionally, the aggregated request 206 may be based on entity type. For example, publishers may provide different pricing for different types of entities. Thus, for example, non-profit organizations may be able to obtain resource licenses at a lower rate than private consumers. Thus, a plurality of requests to the aggregator 202 from non-profit organization entities may be aggregated together to obtain more favorable pricing for those entities. Examples of entity grouping may include, but is not limited to, educational institutions, non-profit organizations, public institutions, private parties, corporations, trade groups, etc.

Alternatively or additionally, the aggregated request 206 may be based on timeframe windows. For example, in some embodiments, all requests received from entities within a given timeframe will be aggregated together in an aggregated request 206. This can be done, for example, to optimize a consumer's ability to consume an electronic resource. For example, DRM may cause a resource to be accessible for a given amount of time after the license is provided by the publisher 102-1. By limiting the time frame in which requests are aggregated, the length of time that DRM allows access can be optimized such that a DRM license is not obtained too soon before a user request thus unduly limiting the amount of time that a user can access a resource.

Alternatively or additionally, the aggregated request 206 may be based on locale. For example, requests may be aggregated such that groups of licenses are requested based on patron or library locale. This may be useful in optimizing delivery times or as a method of demographically grouping patrons and/or licenses. Further, aggregating by locale may allow for culture or location based portions of a work to be more accurately reflected. For example, a work may include reference to a customer support number. Some numbers may be more appropriate for a certain locale than others, and thus, by aggregating licenses based on locale, a more appropriate customer service number may be included in a work.

Alternatively or additionally, the aggregated request 206 may be based on other demographic factors, such as language, environmental conditions, currency, etc. This may allow for demographic factors to be more consistent for patrons. Further, by aggregating by a currency used by patrons, determination of a price for individual patrons may be simplified rather than requiring the use of exchange rates, which can have widely disparate and constantly changing relative values when compared with various other currencies.

Alternatively or additionally, the aggregated request 206 may be based on common DRM restrictions. For example, certain organizations may have DRM restrictions that are particular to those organizations. By aggregating based on organization, licenses can be aggregated by DRM restrictions such that appropriate restrictions and/or licensing requirements are met when finally distributed to patrons.

Alternatively or additionally, the aggregated request 206 may be performed where requesting a number of licenses for the groups or individual resources in a single purchasing transaction from a publisher is performed before receiving a plurality of requests from different customers or patrons for the same groups or individual resources. In these examples, requests from different customers or patrons for the same groups or individual resources are serviced from licenses received as a result of the number of licenses requesting a number of licenses for the groups or individual resources in a single purchasing transaction from a publisher.

Alternatively or additionally, the aggregated request 206 may be based on rate of requests from patrons. For example a high rate, i.e. a number requests received for a work in a short time may result in requesting a higher number of extra licenses, whereas a lower rate of requests from patrons for a work results in a lower number of extra licenses being requested in an aggregated request.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

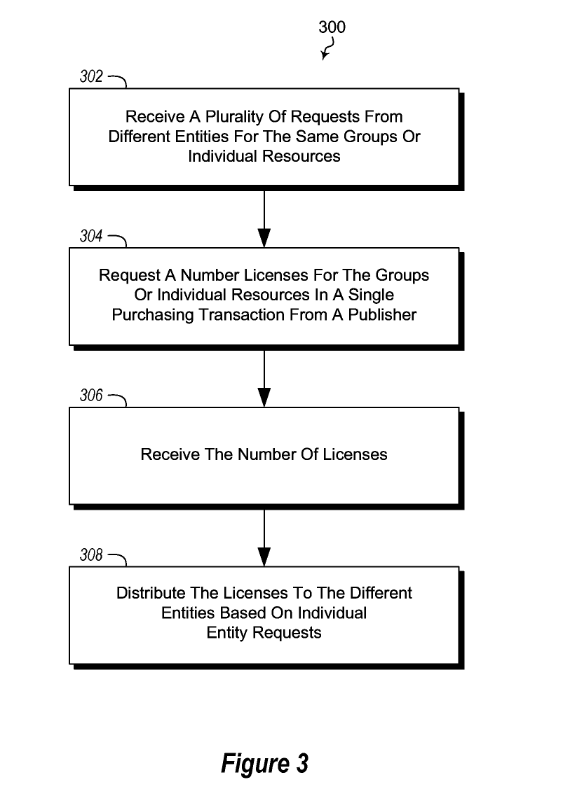

Referring now to FIG. 3, a method 300 is illustrated. The method 300 may be practiced in a digital or in a mixed digital and physical library environment. The method 300 includes acts for acquiring resources for a plurality of customers or patrons. The method 300 includes receiving a plurality of requests from different entities for the same groups or individual resources (act 302). For example, as illustrated in FIG. 2, requests 114-1 through 114-n may be received from different patrons as illustrated by the entities 204-1 through 204-n, for the same electronic resource (e.g. electronic resource 118-1 illustrated in FIG. 1).

The method 300 further includes requesting a number of licenses for the groups or individual resources in a single purchasing transaction from a publisher (act 304). For example, FIG. 2 illustrates an aggregated request 206, which is an aggregation of the requests 114-1 through 114-n. The aggregated request 206 is used to request a block of licenses 208 from a publisher 102-1.

The method 300 further includes receiving the number of licenses (act 306). For example, as illustrated in FIG. 2, the aggregator 202 receives the block of licenses 208.

The method 300 further includes distributing the licenses to the different customers based on individual customer requests. For example, FIG. 2 illustrates individual licenses 120-1, 120-2, 120-3 through 120-n being distributed.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In a digital or mixed digital and physical library environment, a method of acquiring resources for a plurality of customer or patrons, the method comprising:
receiving a plurality of requests from different entities, the different entities being one or more different educational institution libraries, different non-profit organization libraries, different public institution libraries, different corporate libraries, or different trade group libraries for the same resource;
requesting a block of licenses purchased as a block of licenses, the block of licenses including a number of licenses for the resource to be purchased in a single purchasing transaction to purchase the block of licenses from a publisher;
receiving the block of licenses from the publisher; and
distributing different individual licenses in the block of licenses to the different entities, including distributing different licenses from the same block of licenses to one or more different educational institution libraries, different non-profit organization libraries, different public institution libraries, different corporate libraries, or different trade group libraries based on individual entity requests.

2. The method of claim 1, wherein requesting a number of licenses for the resource in a single purchasing transaction from a publisher comprises aggregating license requests by entity type.

3. The method of claim 1, wherein requesting a number of licenses for the resource in a single purchasing transaction from a publisher comprises aggregating license requests by aggregating within a timeframe window.

4. The method of claim 1, wherein requesting a number of licenses for the resource in a single purchasing transaction from a publisher comprises aggregating license requests by location.

5. The method of claim 1, wherein requesting a number of licenses for the resource in a single purchasing transaction from a publisher comprises aggregating license requests by DRM requirements.

6. The method of claim 1, wherein requesting a number of licenses for the resource in a single purchasing transaction from a publisher is performed before receiving a plurality of requests from different entities for the same resource and wherein requests from different entities for the same resource are serviced from licenses received as a result of requesting a number of licenses for the resource in a single purchasing transaction.

7. The method of claim 1, wherein requesting a number of licenses for the resource in a single purchasing transaction from a publisher comprises aggregating license requests based on a rate of requests received from the different entities.

8. In a digital, or mixed digital and physical library environment, a computer readable medium comprising computer executable instructions that when executed by one or more processors cause one or more processors to perform the following:
receiving a plurality of requests from different entities, the different entities being one or more different educational institution libraries, different non-profit organization libraries, different public institution libraries, different corporate libraries, or different trade group libraries for the same resource;
requesting a block of licenses purchased as a block of licenses, the block of licenses including a number of licenses for the resource to be purchased in a single purchasing transaction to purchase the block of licenses from a publisher;
receiving the block of licenses from the publisher; and
distributing different individual licenses in the block of licenses to the different entities, including distributing different licenses from the same block of licenses to one or more different educational institution libraries, different non-profit organization libraries, different public institution libraries, different corporate libraries, or different trade group libraries based on individual entity requests.

9. The computer readable medium of claim 8, wherein requesting a number of licenses for the resource in a single purchasing transaction from a publisher comprises aggregating license requests by entity type.

10. The computer readable medium of claim 8, wherein requesting a number of licenses for the resource in a single purchasing transaction from a publisher comprises aggregating license requests by aggregating within a timeframe window.

11. The computer readable medium of claim 8, wherein requesting a number of licenses for the resource in a single purchasing transaction from a publisher comprises aggregating license requests by location.

12. The computer readable medium of claim 8, wherein requesting a number of licenses for the resource in a single purchasing transaction from a publisher comprises aggregating license requests by DRM requirements.

13. The computer readable medium of claim 8, wherein requesting a number of licenses for the resource in a single purchasing transaction from a publisher is performed before receiving a plurality of requests from different entities for the same resource and wherein requests from different entities for the same resource are serviced from licenses received as a result of requesting a number of licenses for the resource in a single purchasing transaction.

14. The computer readable medium of claim 8, wherein requesting a number of licenses for the resource in a single purchasing transaction from a publisher comprises aggregating license requests based on a rate of requests received from the different entities.

15. In a digital or mixed digital and physical library environment, a computing system configured to acquire resources for a plurality of customer or patrons, the computing system comprising:
one or more processors;
one or more computer readable media coupled to the one or more processors, wherein the one or more computer readable media comprise computer executable instructions that then executed by one or more of the one or more processors cause one or more of the one or more processors to perform the following:
receiving a plurality of requests from different entities, the different entities being one or more different educational institution libraries, different non-profit organization libraries, different public institution libraries, different corporate libraries, or different trade group libraries for the same resource;
requesting a block of licenses purchased as a block of licenses, the block of licenses including a number of licenses for the resource to be purchased in a single purchasing transaction to purchase the block of licenses from a publisher;
receiving the block of licenses from the publisher; and
distributing different individual licenses in the block of licenses to the different entities, including distributing different licenses from the same block of licenses to one or more different educational institution libraries, different non-profit organization libraries, different public institution libraries, different corporate libraries, or different trade group libraries based on individual entity requests.

16. The computing system of claim 15, wherein requesting a number of licenses for the resource in a single purchasing transaction from a publisher comprises aggregating license requests by entity type.

17. The computing system of claim 15, wherein requesting a number of licenses for the resource in a single purchasing transaction from a publisher comprises aggregating license requests by aggregating within a timeframe window.

18. The computing system of claim 15, wherein requesting a number of licenses for the resource in a single purchasing transaction from a publisher comprises aggregating license requests by location.

19. The computing system of claim 15, wherein requesting a number of licenses for the resource in a single purchasing transaction from a publisher comprises aggregating license requests by DRM requirements.

20. The computing system of claim 15, wherein requesting a number of licenses for the resource in a single purchasing transaction from a publisher is performed before receiving a plurality of requests from different entities for the same resource and wherein requests from different entities for the same resource are serviced from licenses received as a result of requesting a number of licenses for the resource in a single purchasing transaction.
